(19) United States
(12) Patent Application Publication
(10) Pub. No.: US 2005/0272474 A1
(43) Pub. Date: Dec. 8, 2005

(54) Controlling the appearance of a hand-portable electronic device

(75) Inventor: Werner Blersch, Burgrieden Hochstetten (DE)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/860,479

(22) Filed: Jun. 3, 2004

(51) Int. Cl. H04M 1/00; H04B 1/38

(52) U.S. Cl. 455/566; 455/550.1; 455/90.1

(57) ABSTRACT

A hand-portable electronic device having an exterior and comprising: a display; at least one light emitting device distinct from the display; means for controlling the presentation of a image on the display; means for determining a first color value that is dependent upon the image; means for converting the first color value to a color control signal; and means for controlling the at least one light emitting device, in response to the color control signal, to emit colored light from at least a portion of the exterior of the hand-portable electronic device.

### FIELD OF THE INVENTION

Embodiments of the invention relate to controlling the appearance of a hand-portable electronic device.

### BACKGROUND TO THE INVENTION

How a hand portable electronic devices look is important to some users. This has resulted in the creation of mobile phones and personal digital assistants that have an adaptable appearance. For example, they may have user-replaceable front covers.

Such hand portable devices, have until recently generally had black and white displays because color displays were too expensive or power hungry. However, it is now more common for hand portable electronic devices to have color displays.

The image presented on the display may be a striking part of the overall appearance of the device.

It would be desirable to provide a hand portable device that has a versatile appearance that may be modified easily when the image presented in the display changes

### BRIEF DESCRIPTION OF THE INVENTION

According to one embodiment there is provided a hand-portable electronic device having an exterior and comprising: a display; at least one light emitting device distinct from the display; means for controlling the presentation of a image on the display; means for determining a first color value that is dependent upon the image; means for converting the first color value to a color control signal; and

means for controlling the at least one light emitting device, in response to the color control signal, to emit colored light from at least a portion of the exterior of the hand-portable electronic device.

According to another embodiment there is provided a method of controlling the exterior appearance of a hand-portable electronic device comprising: displaying a first image on a display of the hand-portable electronic device; determining a first color value dependent upon the first image; converting the first color value to a color control signal; and

controlling at least one light emitting device, using the color control signal, to emit colored light from at least a portion of the device.

According to another embodiment there is provided a hand-portable cellular radio telephone having an exterior and comprising: a display; at least one light emitting device distinct from the display; means for alerting a user to an incoming call by emitting light of a first color from at least a portion of the exterior of the cellular radio telephone; and

means for enabling a user to vary the first color.

According to another embodiment there is provided a hand-portable electronic device having an exterior and comprising: a display; at least one light emitting device distinct from the display; a user input device for inputting a first color value; means for converting the first color value to a color control signal; and

means for controlling the at least one light emitting device, using the color control signal, to emit colored light from at least a portion of the exterior of the hand-portable electronic device.

According to another embodiment there is provided a method of controlling the exterior appearance of a hand-portable electronic device comprising: user inputs a color value;

the device converts the color value to a color control signal and controls at least one light emitting device distinct from any display, using the color control signal, to emit colored light from at least a portion of the device that corresponds to the input color value.

### BRIEF DESCRIPTION OF THE DRAWINGS

For a better understanding of the invention and to understand how the same may be brought into effect reference will now be made by way of example only to the accompanying drawings in which:

FIG. 1A and 1B illustrate respective exterior and interior views of a hand-portable electronic device 10;

FIG. 2 illustrates the functional components of the hand portable device 10; and

FIG. 3 illustrates illumination circuitry.

### DETAILED DESCRIPTION OF EMBODIMENT(S) OF THE INVENTION

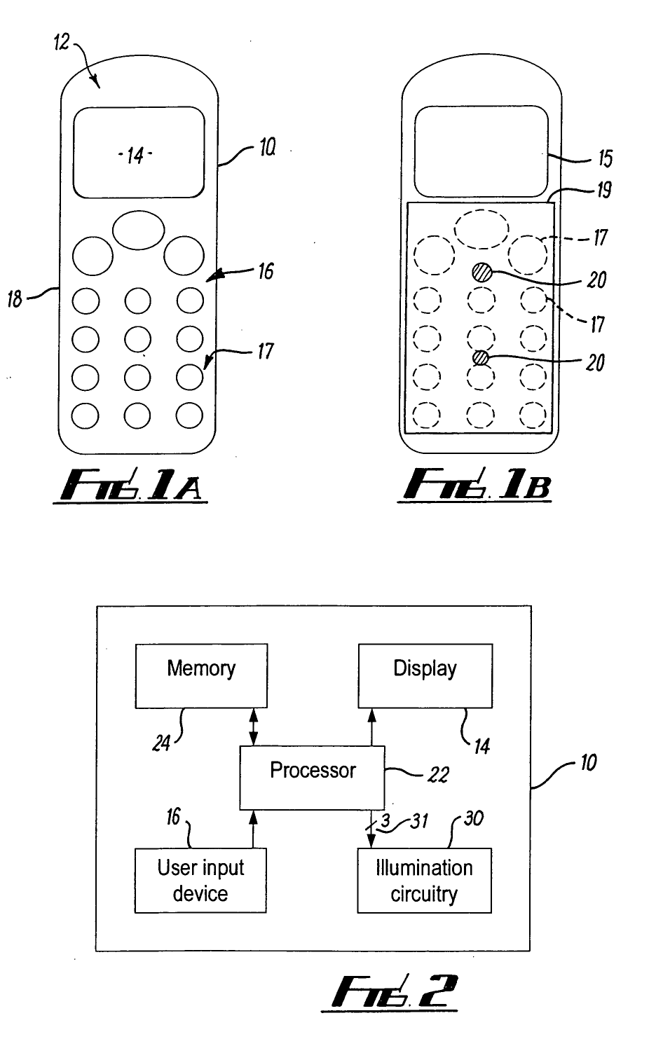

FIG. 1A illustrates a hand-portable electronic device 10 having an exterior 12 and comprising: a display 14 and a user input device 16, which in this example is a keypad. The display 14 and keypad 16 are accessible through apertures in the front face 17 of the body 18 of device 10. The keypad 16 is lit from the interior of the body 18 by a pair of RGB light emitting diode (LED) devices 20 (not shown in FIG. 1A).

FIG. 1B shows a view of the reverse of the front face 17 from the interior of the body 18.

The front face 17 has a display aperture 15 and key aperture 17. A translucent key mat 19 is placed over the key apertures 17 and partially protrudes through the apertures to form the keypad 16. The RGB LEDs are located adjacent the key mat 19. Light guides (not shown) may be used to direct light from the RGB LEDs 20 within the interior of the body 18. In this example, when the RGB LED devices 10 are activated the light they produce is emitted through the keypad 16 thereby illuminating an exterior portion of the device.

In other embodiments all or part of the body 18 may be translucent and light produced by RGB LED devices in the interior of the body may be emitted through the translucent portions of the body thereby illuminating an exterior portion or portions of the device 10.

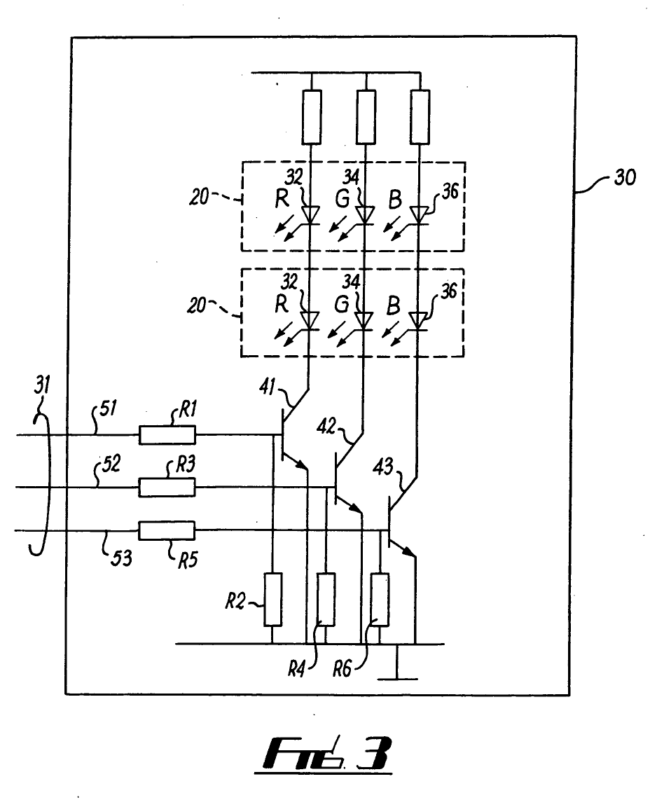

FIG. 2 illustrates the functional components of the device 10. The device 10 comprises the display 14, the user input device 16, a processor 22 and a memory 24. The processor 22 is connected to read from and write to the memory 24, is connected to provide control signals to the display 14 and is connected to receive control signals from the user input device 16. The device 10 also comprises illumination circuitry 30 including the RGB LED devices 20, which are controlled via the illumination control signal 31 by the processor 22. The illumination circuitry 30 is illustrated in more detail in FIG. 3. It illuminates an exterior portion of the device 10, but not necessarily the display 14. In the example described it is used to illuminate the translucent keypad 16 from behind.

The illumination circuitry comprises two RGB LED devices 20. Each RGB LED device comprises a red LED 32, a green LED 34 and a blue LED 36. The red LEDs 32 of the RGB LED devices 20 are connected in series. The electric current through them is controlled by a first current control device 41, which in this example is a bipolar transistor. The green LEDs 34 of the RGB LED devices are connected in series. The electric current through them is controlled by a second current control device 42, which in this example is a bipolar transistor.

The blue LEDs 36 of the RGB LED devices are connected in series. The electric current through them is controlled by a third current control device 43, which in this example is a bipolar transistor.

The control signal 31 from the processor 22 comprises three separate control signals. One of the control signals, the Red control signal 51, is used to control the first current control device 41. The Red control signal 51 is divided by series connected resistors R1 and R2 and the divided signal is provided to the base of the transistor 41. One of the control signals, the Green control signal 52, is used to control the second current control device 42. The Green control signal 52 is divided by series connected resistors R3 and R4 and the divided signal is provided to the base of the transistor 42. One of the control signals, the Blue control signal 53, is used to control the third current control device 43. The Blue control signal 53 is divided by series connected resistors R5 and R6 and the divided signal is provided to the base of the transistor 43.

The processor 22 controls the image presented by the display 14. Typically, the display will comprise an N×M array of pixel clusters, where each pixel cluster comprises a red colored pixel, a green colored pixel and a blue colored pixel. The color produced by a particular pixel cluster (n, m) is determined by the intensity of the red pixel, the intensity of the green pixel and the intensity of the blue pixel. These intensities can be represented as the vector (R, G, B)ₙₘ. An image on the display is defined by an N×M array of such vectors and the processor 22 provides this array as pixel control data to the display 14.

The image presented by the display 14 may include a background image with information such as text presented in the foreground over the background image. Typically such a background image is selectable by a user of the device 10.

The processor 22 is operable to determine a first color value that is dependent upon the image presented on the display 14 and consequently control the illumination circuitry 30 to illuminate an exterior portion of the device 10 with light the color of which is dependent upon the first color value. The processor may determine a new first color value automatically, for example, when the image presented on the display 14 changes or when the background image to the display is changed by a user.

According to a first embodiment, the processor 22 processes the pixel control data to identify a conspicuous color in the display. The first color value may then be set to a value (R1, G1, B1) that attempts to accurately reproduce that conspicuous color or a color similar to it. Alternatively, the first color value may be set to a value (R1, G1, B1) that attempts to accurately reproduce a color that is contradistinctive to the conspicuous color.

The conspicuous color may for example be the predominant color in the image presented on the display or the predominant color in a portion of the image presented. It may alternatively be a particularly vivid color that is present in the displayed image. Typically an algorithm may be used to determine the conspicuous color.

One algorithm associates a single reference color with any one of a plurality of colors than are close to it in the color spectrum. If each reference color cᵢ has an associated vector (Rᵢ, Gᵢ, Bᵢ), then a pixel is associated with that reference color if for the pixel's color vector (R, G, B)ₙₘ:
Rᵢ, −r<Rₙₘ<Rᵢ+r &
Gᵢ, −g<G_{nm<}Gᵢ+g &
Bᵢ−b<B_{nm<}Bᵢ+b

The cᵢ that has the greatest number of pixels associated with it is the predominant color and its vector is set equal to (R1, G1, B1).

The processor then converts the determined first color value (R1, G1, B1) into the illumination control signal 31.

The processor 22 then converts the red illumination value (R1) into the Red control signal 51 using red calibration data stored in the memory 24. Using this red calibration data the processor 22 determines the voltage that needs to be provided by the Red control signal 51, to create the required intensity of red light from the red LED 32. The red calibration data, in this example, depends upon the characteristics of the red LED 32, the values of R1 and R2 and the characteristics of the first current control device 41. The processor 22 also converts the green illumination value into the Green control signal 52 using green calibration data stored in the memory 24. Using this green calibration data, the processor 22 determines the voltage that needs to be provided by the Green control signal 52, to create the required intensity of green light from the green LED 34. The green calibration data, in this example, depends upon the characteristics of the green LED 34, the values of R3 and R4 and the characteristics of the second current control device 42. The processor also converts the blue illumination value into the Blue control signal 53 using blue calibration data stored in the memory 24. Using this blue calibration data, the processor 22 determines the voltage that needs to be provided by the Blue control signal 52, to create the required intensity of blue light from the blue LED 36. The blue calibration data, in this example, depends upon the characteristics of the blue LED 36, the values of R5 and R6 and the characteristics of the second current control device 43.

The processor 22 may provide the illumination control signal 31 to the illumination circuitry 30 automatically whenever the display 14 is in use. Alternatively, the processor 22 may selectively provide the illumination control signal 31 to the illumination circuitry 30. For example, the processor 22 may provide the illumination control signal 31 when the state of the device 10 changes. If the device 10 is a radio cellular telephone, such a change of state may, for example, occur when there is an incoming call or when an alarm, such as an alarm clock, is activated, or when the device wakes-up from a sleep mode.

In the preceding paragraphs, it has been described how the output from the illumination circuitry is made dependent upon the image presented in the display 14. It is also possible to provide a mode in which the color output of the illumination circuitry 30 depends instead upon a color value input by a user using the user input device 16 and stored in the memory 24. The user may update this stored color value should they wish

In the preceding paragraphs, it has been described how the user selects an image for the display and the hand-portable electronic device determines the color to be generated by the LEDs. It is also possible for the user to select the color to be generated by the LEDS. The hand-portable electronic device may then determine the image that is to be displayed, for example, it may select a particular background image that matches the selected color.

Although embodiments of the present invention have been described in the preceding paragraphs with reference to various examples, it should be appreciated that modifications to the examples given can be made without departing from the spirit and scope of the invention.

1. A hand-portable electronic device having an exterior and comprising: a display;
at least one light emitting device distinct from the display;
means for controlling the presentation of a image on the display;
means for determining a first color value that is dependent upon the image;
means for converting the first color value to a color control signal; and
means for controlling the at least one light emitting device, in response to the color control signal, to emit colored light from at least a portion of the exterior of the hand-portable electronic device.

2. A hand-portable electronic device as claimed in claim 1, wherein the display comprises a plurality of pixels, the means for controlling the presentation of an image on the display uses pixel control data that specifies a color for each of a plurality of pixels and the means for determining a first color value, processes the pixel control data.

3. A hand-portable electronic device as claimed in claim 1, wherein the image comprises a conspicuous color and the first color value identifies the conspicuous color.

4. A hand-portable electronic device as claimed in claim 3, wherein the conspicuous color is a predominant color.

5. A hand-portable electronic device as claimed in claim 1, wherein the image has a predominant color and the first color value identifies a color that is contradistinctive to the predominant color.

6. A hand-portable electronic device as claimed in claim 1, wherein the image is a background for the display.

7. A hand-portable electronic device as claimed in claim 1, wherein the image is user selectable.

8. A hand-portable electronic device as claimed in claim 1, wherein the means for converting the determined first color value to a color control signal converts the determined color value to a Red color control signal, a Green color control signal and a Blue color control signal.

9. A hand-portable electronic device as claimed in claim 8, wherein the conversion of first color value to the red color control signal is dependent upon the characteristics of the light emitting device used to emit red light, the conversion of first color value to the green color control signal is dependent upon the characteristics of the light emitting device used to emit green light and the conversion of first color value to the blue color control signal is dependent upon the characteristics of the light emitting device used to emit blue light.

10. A hand-portable electronic device as claimed in claim 1, wherein the means for converting the determined first color value to a color control signal uses calibration data dependent upon the at least one light emitting device

11. A hand-portable electronic device as claimed in claim 1, wherein the means for controlling the at least one light emitting device, provides the color control signal to the at least one light emitting device when the state of the hand-portable device changes.

12. A hand-portable electronic device as claimed in claim 11, wherein the hand-portable device is a radio cellular telephone having a state that changes when receiving an incoming but unanswered call.

13. A hand-portable electronic device as claimed in claim 1, wherein the portion of the exterior of the hand-portable device that is illuminated comprises a keypad.

14. A hand-portable electronic device as claimed in claim 1, wherein the at least one light emitting device comprises a RGB LED device that comprises a red LED, a green LED and a blue LED.

15. A hand-portable electronic device as claimed in claim 1 comprising a plurality of LEDs connected in series, and a current control device for controlling the current through the serially connected LEDs.

16. A hand-portable electronic device as claimed in claim 1, operable as a cellular mobile telephone.

17. A method of controlling the exterior appearance of a hand-portable electronic device comprising:
displaying a first image on a display of the hand-portable electronic device;
determining a first color value dependent upon the first image;
converting the first color value to a color control signal; and
controlling at least one light emitting device, using the color control signal, to emit colored light from at least a portion of the device.

18. A hand-portable cellular radio telephone having an exterior and comprising:
a display;
at least one light emitting device distinct from the display;
means for alerting a user to an incoming call by emitting light of a first color from at least a portion of the exterior of the cellular radio telephone; and
means for enabling a user to vary the first color.

19. A hand-portable cellular radio telephone as claimed in claim 18, wherein the user selects the first color.

20. A hand-portable cellular radio telephone as claimed in claim 18, wherein the means for alerting the user to an incoming call also illuminates the display using a first image
and the means for enabling a user to vary the first color comprises means for varying the first image, wherein the first color is dependent upon the first image.

21. A hand-portable electronic device having an exterior and comprising: a display;
at least one light emitting device distinct from the display;
a user input device for inputting a first color value;
means for converting the first color value to a color control signal; and
means for controlling the at least one light emitting device, using the color control signal, to emit colored light from at least a portion of the exterior of the hand-portable electronic device.

22. A hand-portable electronic device as claimed in claim 21, further comprising means for determining the image that is displayed in the display in dependence upon the first color value.

23. A hand-portable electronic device as claimed in claim 22, wherein the means for determining the image to be displayed identifies an image for display that gas a conspicuous color that matches the first color value.

24. A method of controlling the exterior appearance of a hand-portable electronic device comprising:
user inputs a color value;
the device converts the color value to a color control signal and controls at least one light emitting device distinct from any display, using the color control signal, to emit colored light from at least a portion of the device that corresponds to the input color value.
